(19) United States
(12) Patent Application Publication
(10) Pub. No.: US 2021/0187782 A1
(43) Pub. Date: Jun. 24, 2021

(54) IMPROVED FLAME RETARDANCY OF WOOD AND OTHER CELLULOSE-BASED MATERIALS BY IN-SITU MINERALIZATION

(71) Applicant: ETH ZÜRICH, Zürich (CH)

(72) Inventors: Huizhang Guo, Zürich (CH); Ingo BURGERT, Zürich (CH)

(73) Assignee: ETH ZÜRICH, Zürich (CH)

(21) Appl. No.: 16/757,396

(22) PCT Filed: Oct. 18, 2018
(86) PCT No.: PCT/EP2018/078655

§ 371 Date: Apr. 19, 2020

(30) Foreign Application Priority Data
Oct. 18, 2017 (EP) 17197159.1

(51) Int. Cl. B27K 3/32; B27K 3/20; B27K 3/02

(52) U.S. Cl. CPC B27K 3/32; B27K 2240/30; B27K 3/0292; B27K 3/20

(57) ABSTRACT

The invention relates to a method for the treatment of cellulosic material. The method is comprising the steps of impregnation of the cellulosic material and treatment of the impregnated cellulosic material by a fumigation step or an evaporation step. Impregnation is performed with a metal ion M and at least one ion precursor Z yielding an impregnated cellulosic material. The at least one ion precursor Z provides an anion A or an anion A and a cation Y comprised within at least one metal salt solution I or with a metal salt solution II comprising a metal ion M. The fumigation or evaporation step is yielding a cellulosic composite material comprising a compound M(NH4)A, MYA or M(OH)x, wherein M is a metal.

### FIELD OF THE INVENTION

The present invention relates to flame retardant wood material and methods for producing such materials.

### BACKGROUND

Flammability has been a long-standing challenge for the application of wood and engineered wood products in construction, automotive industry, aviation and yachting. Therefore, flame-retardant materials, which are designed to burn slowly and prevent the spread of fire, hold a huge market demand. The traditionally used halogenated compounds, which act as effective flame retardants and smoke inhibitors have been banned globally owing to the increasing arguments on their toxicity upon combustion. As a result, organophosphorus flame retardants are nowadays widely used in various products as a main replacement. However, there are increasing concerns about the pollution to water resources and soil. Given the societal demands of increased use of green, sustainable materials, new technologies are strongly desired for the development of next-generation flame retardant cellulose based products. Four requirements arise:
1) efficiency of flame retardant,
2) odor free and environmental friendly,
3) preserving the aesthetic appearance of the substrate (e.g. wood) and
4) a straightforward economical method to embed the compounds into the complex structures.

Based on the above-mentioned state of the art, the objective of the present invention is to provide a method to improve the flame retardancy of wood and other cellulose-based materials by in-situ mineralization. This objective is attained by the claims of the present specification.

### Terms and Definitions

In the context of the present invention, the terms “cellulosic material” and “cellulose-based materials” are used interchangeably. They relate to a material that comprises cellulose.

The term “base additive” relates to a base according to the definition of Brønsted and Lowry (“proton acceptor”).

### DESCRIPTION

An efficient fire retardant material for wood should possess the following technological features: (i) it insulates wood against air by a covering effect; (ii) it can release nonflammable protective gases; (iii) it absorbs heat released on the surface of the material; (iv) it catalyzes wood to be carbonized. Beside the characteristics of the material, a facile manufacturing process is of equal importance from the view of practical application.

The present invention relates to a method for the treatment of cellulose-based materials to achieve flame retardant properties. Non-limiting examples of cellulose-based materials are timber, wood veneers, fiberboards, paper and textiles. More specifically, the present invention relates to an in-situ artificial mineralization process which results in a coating, which in case of wood based materials is not only on the surface of the bulk material, but also on the surfaces of the cell walls inside the wood material. The mineralization is achieved by a fumigation or evaporation procedure of previously impregnated cellulosic material. Compared to the prior art, the advantages of this invention include:
1) the fire retardant relies on the decomposition of the compound;
2) the aqueous based salt impregnation results in a green manufacturing process;
3) in case of a fumigation step ammonia steam is used as reactant making the process facile for the products with various dimensions and resulting in more homogeneous mineral distribution in the complex wood structure;
4) the mineral keeps the aesthetic appearance of wood.

The methods disclosed by present invention are also applicable to but not restricted to other cellulose based materials such as wood, fiberboard, paper and textile.

According to a first aspect of the invention a method for the treatment of cellulosic material is provided. The method is comprising the steps of

a. impregnation of the cellulosic material, and
b. treatment of the impregnated cellulosic material by fumigation or evaporation.

In certain embodiments, the cellulosic material is impregnated with a metal ion M and at least one ion precursor Z, wherein the at least one ion precursor Z provides an anion A. M, Z and A are comprised within at least one metal salt solution I, yielding an impregnated cellulosic material. In other words M and Z may be comprised in different metal salt solutions I.

In certain embodiments, the cellulosic material is impregnated with a metal ion M and at least one ion precursor Z, wherein the at least one ion precursor Z provides an anion A and a cation Y comprised within at least one metal salt solution I, yielding an impregnated cellulosic material. In this embodiment in case of more than one metal salt solution I different ion precursors Z are comprised in different metal salt solutions I therefore the anion A and the cation Y are provided from different ion precursors Z.

In certain embodiments, the cellulosic material is impregnated with a metal salt solution II comprising a metal ion M, yielding an impregnated cellulosic material.

A counterion Q for the metal M in salt solution I or II may be selected from acetate, phosphate, sulfate, chloride, bromide, iodide or nitrate, in particular sulfate, acetate or phosphate, more particularly sulfate.

The concentration of MQ may range from 10 mg/ml to a saturated solution, in particular from 50 mg/ml to a saturated solution.

In certain embodiments, the impregnated cellulosic material is treated by a fumigation step or an evaporation step yielding a cellulosic composite material comprising a compound M(NH₄)A, wherein M is a metal cation and A is an anion. The NH₄⁺ ion is provided by the compound used in the fumigation or evaporation step.

In certain embodiments, the impregnated cellulosic material is treated by a fumigation step or an evaporation step yielding a cellulosic composite material comprising a compound MYA, wherein M is a metal cation, Y is a cation and A is an anion.

In certain embodiments, the impregnated cellulosic material is treated by a fumigation step or an evaporation step yielding a cellulosic composite material comprising said compound M(OH)ₓ, wherein M is a metal cation and x equals the oxidation number of M.

The advantage of using fumigation after the impregnation step instead of a treatment with a liquid compound is to avoid the direct contact of impregnated wood with liquid that could result in a leaching of the impregnated salt. Without wishing to be bound by theory the inventors believe that the use of fumigation increases the yield of compound synthesized in situ, and results in a more homogeneous distribution of the insoluble compound in complex structures.

In general the use of at least one metal salt solution I comprising Z and A yields a cellulosic composite material M(NH₄)A. The use of at least one metal salt solution I comprising Z, A and Y yields a cellulosic composite material MYA. The use of a metal salt solution II yields a cellulosic material M(OH)ₓ.

In certain embodiments, the impregnated cellulosic material is fumigated with NH₃.

In certain embodiments, the at least one ion precursor Z of said metal salt solution I provides an anion A in the impregnation step and NH₃ is used in the fumigation step.

In certain embodiments, the metal salt solution II is used in the impregnation step and NH₃ is used in the fumigation step.

In certain embodiments, the at least one ion precursor Z of the metal salt solution I provides an anion A and a cation Y or at least two ion precursors Z of said metal salt solution I provide an anion A and a cation Y, wherein one ion precursor Z provides an anion A and the other ion precursor Z provides a cation Y, in the impregnation step followed by an evaporation step.

In certain embodiments, the evaporation occurs with the proviso that a base additive is not added.

In certain embodiments, M is in the case of metal salt solution I selected from Mg²⁺, Ca²⁺, Sr²⁺, Ba²⁺ and Zn²⁺, Fe²⁺.

In certain embodiments, M is in the case of metal salt solution I selected from Mg²⁺, Ca²⁺, Ba²⁺ and Zn²⁺.

In certain embodiments, M is in the case of metal salt solution I selected from Mg²⁺ and Zn²⁺.

In certain embodiments, M is in the case of metal salt solution II selected from Al³⁺, Mg²⁺, Zn²⁺, Ni²⁺, In³⁺, Fe²⁺ and Fe³⁺

In certain embodiments, M is in the case of metal salt solution II selected from Al³⁺ and Mg²⁺.

In certain embodiments, M is in the case of metal salt solution II selected from Al³⁺.

In certain embodiments, Y is selected from an alkali metal ion and NH₄⁺.

In certain embodiments, Y is selected from NH₄⁺, Li⁺, Na⁺ and K.

In certain embodiments, Y is selected from NH₄⁺ and—if the evaporation step is applied in step b—K⁺.

In certain embodiments, A is phosphate.

In certain embodiments, the fumigation is performed for 1 to 24 hours.

In certain embodiments, the fumigation is performed for 1 to 12 hours,

In certain embodiments, the fumigation is performed for 3 to 6 hours.

According to an alternative to the first aspect of the invention a method for the treatment of cellulosic material is provided. The method is comprising the steps:
a′. impregnation of the cellulosic material with a metal salt solution II comprising a metal ion M, and
b′. treatment of the impregnated cellulosic material with a base additive yielding a cellulosic composite material comprising said compound M(OH)ₓ, wherein M is a metal cation and x equals the oxidation number of M.

In certain embodiments, M is selected from Al³⁺, Mg²⁺, Zn²⁺, Ni²⁺ Fe²⁺, Fe³⁺, Ca²⁺, Mn²⁺, Co²⁺ and In³⁺.

In certain embodiments, M is selected from Al³⁺ and Mg²⁺.

In certain embodiments, M is selected from Al³⁺.

A counterion Q for the metal M may be selected from acetate, phosphate, sulfate, chloride, bromide, iodide or nitrate, in particular sulfate, acetate or phosphate, more particularly sulfate.

The concentration of MQ may range from 10 mg/ml to a saturated solution, in particular from 50 mg/ml to a saturated solution.

In certain embodiments according to all aspects of the invention the impregnation is performed by vacuum/high pressure impregnation, immersion or spraying. In the context of the present invention immersion is to be understood without any implication towards the duration of the immersion. It includes a short time treatment in the sense of “dipping” as well as a longer duration of treatment in the sense of “soaking”.

In certain embodiments according to all aspects of the invention the impregnation is performed by immersion or spraying.

In certain embodiments according to the first aspect of the invention in the case of metal salt solution I, a protic solvent is used for the impregnation step.

In certain embodiments according to the first aspect of the invention in the case of metal salt solution I, alcohol or water is used for the impregnation step.

In certain embodiments according to the first aspect of the invention in the case of metal salt solution I, water is used for the impregnation step.

In certain embodiments according to the first aspect of the invention in the case of metal salt solution II, a solvent with a water content of at least 10% is used for the impregnation step.

In certain embodiments according to the first aspect of the invention in the case of metal salt solution II, a protic solvent is used for the impregnation step.

In certain embodiments according to the first aspect of the invention in the case of metal salt solution II, alcohol or water is used for the impregnation step.

In certain embodiments according to the first aspect of the invention in the case of metal salt solution II, water is used for the impregnation step.

In certain embodiments according to the first aspect of the invention during the impregnation a negative pressure is applied.

In certain embodiments according to the first aspect of the invention during the impregnation a pressure of 1 mbar to 800 mbar is applied.

In certain embodiments according to the first aspect of the invention during the impregnation a pressure of 5 mbar to 50 mbar is applied.

In certain embodiments according to the first aspect of the invention during the impregnation a positive pressure is applied.

In certain embodiments according to the first aspect of the invention during the impregnation a pressure of 3 bar to 25 bar is applied.

In certain embodiments according to the first aspect of the invention during the impregnation a pressure of 6 bar to 9 bar is applied.

In certain embodiments according to the first aspect of the invention during the treatment with a base additive a negative pressure is applied.

In certain embodiments according to the first aspect of the invention during the treatment with a base additive a pressure of 1 mbar to 800 mbar is applied.

In certain embodiments according to the first aspect of the invention during the treatment with a base additive a pressure of 5 mbar to 50 mbar is applied.

In certain embodiments according to the first aspect of the invention during the treatment with a base additive a positive pressure is applied.

In certain embodiments according to the first aspect of the invention during the treatment with a base additive a pressure of 3 bar to 25 bar is applied.

In certain embodiments according to the first aspect of the invention during the treatment with a base additive a pressure of 6 bar to 9 bar is applied.

In certain embodiments according to the first aspect of the invention during the impregnation and treatment with a base additive a negative pressure is applied.

In certain embodiments according to the first aspect of the invention during the impregnation and treatment with a base additive a pressure of 1 mbar to 800 mbar is applied.

In certain embodiments according to the first aspect of the invention during the impregnation and treatment with a base additive a pressure of 5 mbar to 50 mbar is applied.

In certain embodiments according to the first aspect of the invention during the impregnation and treatment with a base additive a positive pressure is applied.

In certain embodiments according to the first aspect of the invention during the impregnation and treatment with a base additive a pressure of 3 bar to 25 bar is applied.

In certain embodiments according to the first aspect of the invention during the impregnation and treatment with a base additive a pressure of 6 bar to 9 bar is applied.

In certain embodiments according to the first aspect of the invention the treated cellulosic material is dried after step b or b′.

In certain embodiments according to the first aspect of the invention the treated cellulosic material is subject to a heat treatment after step b or b′. In certain embodiments the heat treatment is performed at a temperature of 40° C. to 103° C. In certain embodiments the heat treatment is performed at a temperature of 55° C. to 70° C. In certain embodiments the heat treatment is performed at a temperature of 60° C. to 65° C. In certain embodiments the heat treatment is performed at a temperature of 65° C.

According to a second aspect of the invention a cellulosic composite material obtainable by a method according to the first aspect of the invention is provided. The cellulosic composite material is characterized by a limiting oxygen index (LOI) of 30 to 60 and/or or a weight percentage of the compound M(NH₄)A, MYA or M(OH)ₓ of 5 wt % to 60 wt %.

In certain embodiments the LOI is in the range of 35 to 55.

In certain embodiments the LOI is in the range of 40 to 50.

In certain embodiments the weight percentage of the compound M(NH₄)A, MYA or M(OH)ₓ; is in the range of 30 wt % to 55 wt %.

In certain embodiments the weight percentage of the compound M(NH₄)A, MYA or M(OH)ₓ; is in the range of 40 wt % to 55 wt %.

The limiting oxygen index (LOI) is the minimum concentration of oxygen, expressed as a percentage, that will support combustion of a material. It is measured by passing a mixture of oxygen and nitrogen over a burning specimen, and reducing the oxygen level until a critical level is reached. A material combusts more easily the lower the LOI of the material is. Air has an oxygen percentage of around 21%. Materials with a LOI above 21 are self-extinguishing under standard conditions.

According to a third aspect of the invention a cellulosic composite material comprising a compound M(NH₄)A, MYA or M(OH)ₓ is provided. The compound is present on the surface of the cell wall, in particular on the lumen surface of the cell wall. M is a metal cation, Y is a cation, A is an anion and x equals the oxidation number of M, with the proviso that the compound is not MgNH₄PO₄.

In certain embodiments, the cellulosic composite material is characterized by a limiting oxygen index (LOI) of 30 to 60.

In certain embodiments the LOI is in the range of 35 to 55.

In certain embodiments the LOI is in the range of 40 to 50.

In certain embodiments the weight percentage of the compound M(NH₄)A, MYA or M(OH)ₓ; is in the range of 5 wt % to 60 wt %.

In certain embodiments the weight percentage of the compound M(NH₄)A, MYA or M(OH)ₓ; is in the range of 30 wt % to 55 wt %.

In certain embodiments the weight percentage of the compound M(NH₄)A, MYA or M(OH)ₓ; is in the range of 40 wt % to 55 wt %.

In general, the wt % of M(NH₄)A, MYA or M(OH)ₓ in relation to the cellulosic composite material is also affected by the dimension of the material. Thinner material would contain a higher wt % of MYA or M(OH)ₓ than thicker material.

Cellulosic material specimens with less than 10 mm thickness would have a wt % of M(NH₄)A, MYA or M(OH)ₓ in relation to the cellulosic composite material up to 75 wt %.

Cellulosic material specimens with more than 10 mm thickness would have a wt % of M(NH₄)A, MYA or M(OH)ₓ in relation to the cellulosic composite material of 15 wt % to 60 wt %.

In certain embodiments, the solubility of M(NH₄)A, MYA or M(OH)ₓ in a protic solvent is below 0.01 g/ml.

In certain embodiments, the solubility of M(NH₄)A, MYA or M(OH)ₓ in alcohol or water is below 0.01 g/ml.

In certain embodiments, the solubility of M(NH₄)A, MYA or M(OH)ₓ in water is below 0.01 g/ml.

In certain embodiments according to all aspects of the invention, wherein the compound M(NH₄)A decomposes and releases crystal water at a temperature below 200° C.

In certain embodiments according to all aspects of the invention, wherein the compound M(NH₄)A decomposes and releases crystal water at a temperature below 150° C.

In certain embodiments according to all aspects of the invention, wherein the compound

MYA decomposes and releases crystal water at a temperature below 200° C.

In certain embodiments according to all aspects of the invention, wherein the compound MYA decomposes and releases crystal water at a temperature below 150° C.

In certain embodiments according to all aspects of the invention, wherein the compound M(OH)ₓ decomposes and releases crystal water at a temperature below 350° C.

In certain embodiments according to all aspects of the invention, wherein the compound M(OH)ₓ decomposes and releases crystal water at a temperature below 300° C.

In certain embodiments according to all aspects of the invention, wherein the compound M(OH)ₓ decomposes and releases crystal water at a temperature below 280° C.

Decomposition of the compound M(NH₄)A, MYA or M(OH)ₓ results in thermal absorption. The released crystal water can dilute the flammable gases.

In certain embodiments according to all aspects of the invention, M is selected in the case of M(NH₄)A, from Mg²⁺, Ca²⁺, Sr²⁺, Ba²⁺ and Zn²⁺.

In certain embodiments according to all aspects of the invention, M is selected in the case of M(NH₄)A, from Mg²⁺, Ca²⁺, Ba²⁺ and Zn²⁺.

In certain embodiments according to all aspects of the invention, M is selected in the case of M(NH₄)A, from Mg²⁺ and Zn²⁺.

In certain embodiments according to all aspects of the invention, M is selected in the case of MYA, from Mg²⁺, Ca²⁺, Sr²⁺, Ba²⁺ and Zn²⁺.

In certain embodiments according to all aspects of the invention, M is selected in the case of MYA, from Mg²⁺, Ca²⁺, Ba²⁺ and Zn²⁺.

In certain embodiments according to all aspects of the invention, M is selected in the case of MYA, from Mg²⁺ and Zn²⁺.

In certain embodiments according to all aspects of the invention, M is selected in the case of M(OH)ₓ, from Al³⁺, Mg²⁺, Zn²⁺, Ni²⁺ and In³⁺.

In certain embodiments according to all aspects of the invention, M is selected in the case of M(OH)ₓ, from Al³⁺ and Mg²⁺.

In certain embodiments according to all aspects of the invention, M is selected in the case of M(OH)ₓ, from Al³⁺.

### BRIEF DESCRIPTION OF THE FIGURES

FIG. 1 shows backscatter electron (Z contrast) images of the cross section of unmodified (a) and modified (b) wood veneers. (c) EDX spectrum acquired from the modified wood; (d) EDX mapping on the cross section of the cell wall of modified wood.

FIG. 2 shows TGA (black) and dTG plots (grey) of pure aluminum hydroxide (a), unmodified wood (b) and modified wood (c).

FIG. 3 shows TG (black) and DTG (grey) curves of the spruce veneer (a), beech veneer (b) and paper sheets (c) with different amount of mineral. Samples numbers correspond to the sample numbers in tables 3-5. Sample 1: 0 g/ml aluminum sulfate hydrate; sample 2: 50 mg/ml aluminum sulfate hydrate; sample 5: 350 mg/ml aluminum sulfate hydrate.

FIG. 4 shows XRD pattern of the Struvite powder generated by ammonium fumigation (black line) and the XRD pattern of the Struvite powder washed by water (grey line).

FIG. 5 shows the TG (black) and DTG (grey) curves of the as-synthesized Struvite (a) after drying at 65° C. oven (a) and the TG (black) and DTG (blue) curves of spruce wood embedded with Struvite (b). Untreated reference sample for spruce see FIG. 3, sample 1.

FIG. 6 shows the relationship of mass gain and LOI value of spruce veneer with Struvite minerals.

### EXAMPLES

### Example 1: Insertion of Aluminum Hydroxide

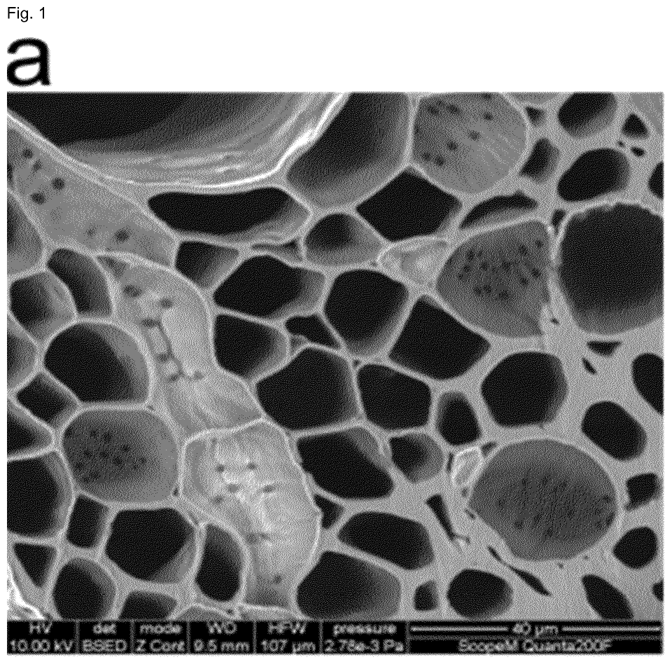

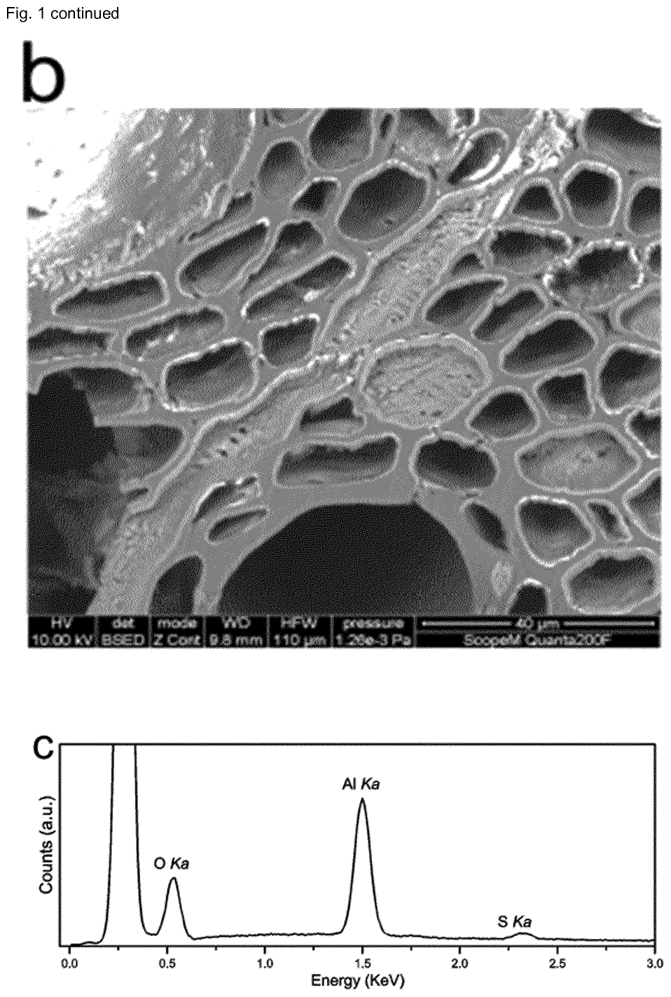

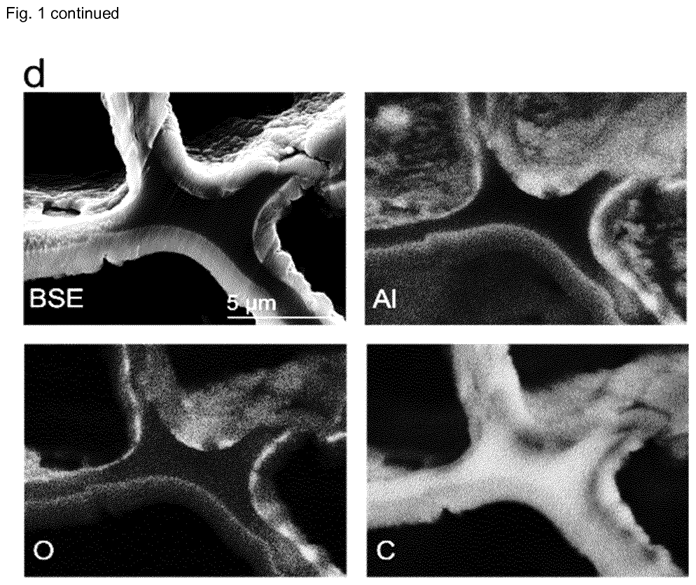

In the invention a continuous metal hydroxide film is deposited onto the inner and outer surfaces of wood cell walls via a facile mineralization process yielding a flame retardant wood product. The natural appearance of the surface of the wood material is preserved after treatment. The main features include that precursors are impregnated into the targeted substrate in the first step; afterwards, the materials are transferred into a plastic box containing ammonium hydroxide solution. The ammonia steam dissolves into the aqueous salt solution that has been impregnated into wood, and results in the deposition of the minerals such as aluminum hydroxide. FIGS. 1a and b exhibit the z-contrast images of the cross sections of the wood before and after treatment. The brighter layer on the lumen surface of the modified wood is attributed to the mineral layer (FIG. 1b). The presence of aluminum hydroxide is proved by energy-dispersive X-ray spectroscopy (EDX, FIG. 1c), from which the signal from aluminum is observed together with a stronger oxygen peak compared to the unmodified wood. EDX mapping was further applied to check the component distribution on the wood cell wall. As illustrated in FIG. 1d, aluminum is mainly present on the surface of cell wall, and a higher oxygen contrast is found on the surface of cell wall compared to the inside of the cell wall. The results indicate that there is a continuous and dense aluminum hydroxide layer with a thickness of around 1.3 μm on the lumen surface, which functions as an inner cell wall surface coating.

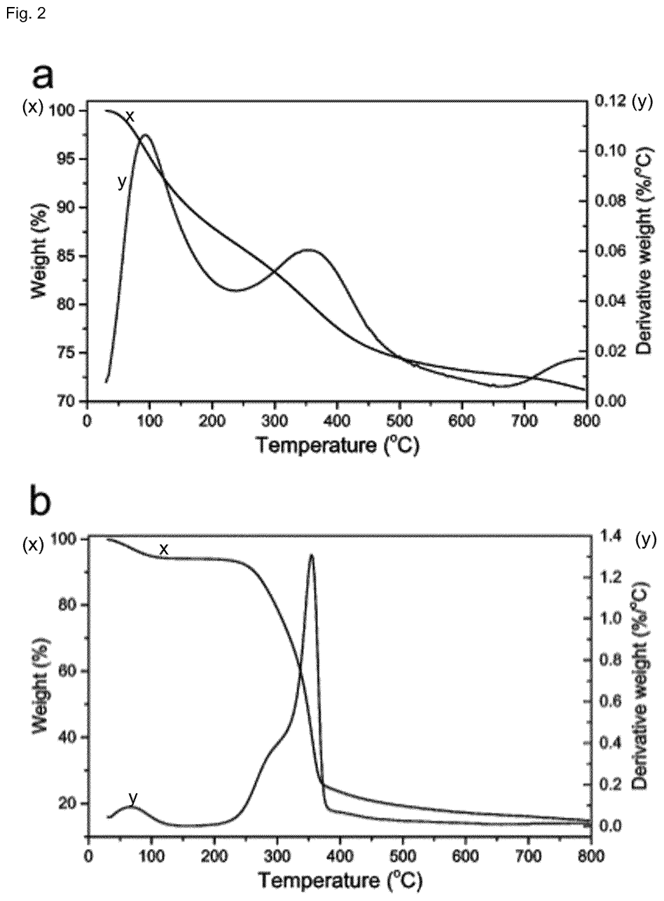

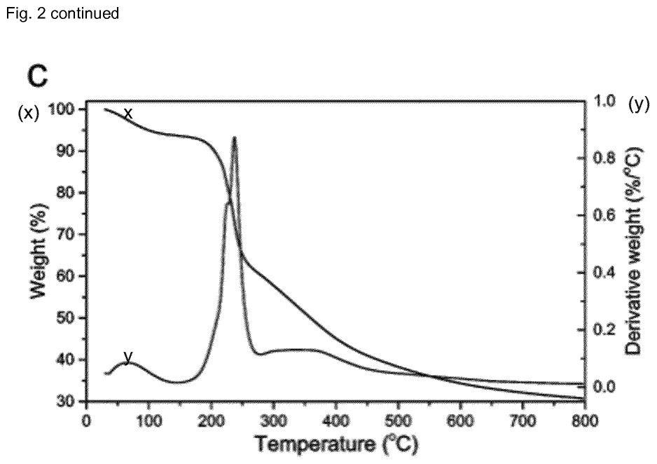

Besides its function as an insulation layer, the aluminum hydroxide film will decompose prior to wood. The decomposition process absorbs heat on the surface of the wood cell wall, and generates water which acts as nonflammable protective gas by diluting the flammable gases. It is important to notice that, since water is the only emission compound during the decomposition process, there is no problem of toxicity upon combustion. FIG. 2a displays the mass loss as a function of temperature for the pure aluminum hydroxide precipitated by the reaction between aluminum sulfate and ammonia steam, which displays a majority of mass loss below 450° C. owing to the release of the physically adsorbed water as well as the crystal water. The thermogavimetric (TG) and DTG curves of unmodified wood are shown in FIG. 2b, which demonstrate that the unmodified wood has a sharp weight loss in a very narrow temperature window between 250° C. and 370° C. during the pyrolysis. Comparing FIGS. 2a and b shows that aluminum hydroxide decomposes at a lower temperature, or with partly overlap with the decomposition temperature of wood. The thermal absorption and water emission by the aluminum hydroxide decomposition retards the wood material from burning. Furthermore, the aluminum oxide resulted from the decomposition process will function as a dense air shelter, which facilitates carbonization instead of combustion of the cell walls. FIG. 2c display the TG and DTA curves of the modified wood. There are three main weight loss regions: The one before 100° C. is owing to the evaporation of moisture in wood. Different from the unmodified wood, the rapidest weight loss observed from the TG curve (FIG. 2c, black line) is located in a temperature range between approximately 180° C. to 280° C., which is attributed to the releasing of crystal water from aluminum hydroxide hydrate, which is consistent with the highest peaks observed in the DTG curve (FIG. 2c, grey line). The wood material starts to decompose at a temperature higher than 270° C., but shows a very slow weight loss speed. A possible explanation is that the surface of the wood cell wall is covered by a layer of Al₂O₃ as a result of the decomposition of aluminum hydroxide hydrate.

The fire-retardant performance of modified wood veneers was assessed by the Limiting Oxygen Index (LOI) measurement. A significant increase in both the LOI value and the amount of residues after burning was observed. The unmodified wood has a LOI value of 20.0 with 0.5% residue, while the modified wood (by soaking in step a and fumigation in step b) has a LOI of 27.3 with 11.1% residue (Table 1). In addition, smoldering was observed in the untreated wood sample, giving rise to grey residues. This was not observed for the treated wood sample.

TABLE 1
Limited oxygen index measurement

| | LOI | Residue | Smouldering | Color of residue |
|---|---|---|---|---|
| Unmodified Veneer | 20.0 | 0.5% | Yes | Grey |
| Modified Veneer | 27.3 | 11.1% | No | Black |

An optimized process was carried out by using vacuum impregnation to increase the weight percentage of minerals in the targeted materials. The process includes loading the samples in a plastic box into a vacuum chamber; after pumping the chamber to a targeted vacuum, the salt solution was injected into the plastic box until the samples were covered by the solution; then the vacuum pump was closed, and the samples were kept inside the chamber for certain time. After the vacuum impregnation, ammonium fumigation as mentioned before was conducted (specifications about vacuum, duration etc. are described in examples 3 to 8).

The mass gain of samples impregnated under vacuum was changed by using solutions with different salt concentrations. Wood panels with a dimension of 100 mm×100 mm×10 mm in longitudinal×radial×tangential direction were impregnated with aqueous solution of aluminum sulfate hydrate with concentrations in the range from 0 mg/mL to 350 mg/mL. As shown in Table 2, the mass gain of beech wood (hardwood) as well as spruce wood (softwood) increased as the concentrations of aluminum sulfate hydrate solution increased, which shows that the amount of minerals inside different wood species can be controlled.

TABLE 2
Mass gain of beech and spruce planes

| | | | Mass | Mass |
|---|---|---|---|---|
| | | | Gain of | Gain of |
| | Aluminum sulfate hydrate | | beech | Spruce |
| Sample Number | concentration | | wood | wood |
| 1 | 0 | g/mL | 0% | 0% |
| 2 | 50 | mg/mL | 4.17% | 3.60% |
| 3 | 150 | mg/mL | 11.89% | 12.55% |
| 4 | 250 | mg/mL | 14.72% | 16.25% |
| 5 | 350 | mg/mL | 19.58% | 17.43% |

To study the relationship between the mass gain and the fire retardant performance, LOI measurements were performed on the wood veneers and paper sheets with different amount of minerals. The same vacuum impregnation and fumigation used for wood panels treatment were carried out on the spruce veneers with a thickness of 0.84 mm, beech veneers with a thickness of 0.55 mm, and paper sheets (Coop Q+P Notizblock, Produced in Austria) with a thickness of 0.1 mm. Table 3 to 5 demonstrate that the mass gain of the modified samples increase as higher concentrations of aluminum sulfate hydrate solution were used and that the higher mass gain resulted in higher LOI index.

TABLE 3
The mass gain and LOI index of spruce veneers impregnated with
different concentrations of aluminum sulfate hydrate solution.

| | Aluminum sulfate hydrate | | Mass gain of | |
|---|---|---|---|---|
| Sample Number | concentration | | spruce veneer | LOI |
| 1 | 0 | g/mL | 0% | 20.8 |
| 2 | 50 | mg/mL | 14.00% | 34.57 |
| 3 | 150 | mg/mL | 33.42% | 50.73 |
| 4 | 250 | mg/mL | 44.67% | 56.67 |
| 5 | 350 | mg/mL | 57.96% | 58.9 |

TABLE 4
The mass gain and LOI index of beech veneers impregnated with
different concentrations of aluminum sulfate hydrate solution.

| | Aluminum sulfate hydrate | | Mass gain of | |
|---|---|---|---|---|
| Sample Number | concentration | | beech veneer | LOI |
| 1 | 0 | g/mL | 0% | 20.83 |
| 2 | 50 | mg/mL | 4.27% | 23.6 |
| 3 | 150 | mg/mL | 14.72% | 31.57 |
| 4 | 250 | mg/mL | 18.98% | 35.57 |
| 5 | 350 | mg/mL | 26.60% | 41.1 |

TABLE 5
The mass gain and LOI index of paper sheets impregnated with different
concentrations of aluminum sulfate hydrate solution.

| | Aluminum sulfate hydrate | | Mass gain of | |
|---|---|---|---|---|
| Sample Number | concentration | | Paper sheet | LOI |
| 1 | 0 | g/mL | 0% | 18.97 |
| 2 | 50 | mg/mL | 16.52% | 25.5 |
| 3 | 150 | mg/mL | 26.86% | 27.7 |
| 4 | 250 | mg/mL | 34.93% | 32.23 |
| 5 | 350 | mg/mL | 40.58% | 38.2 |

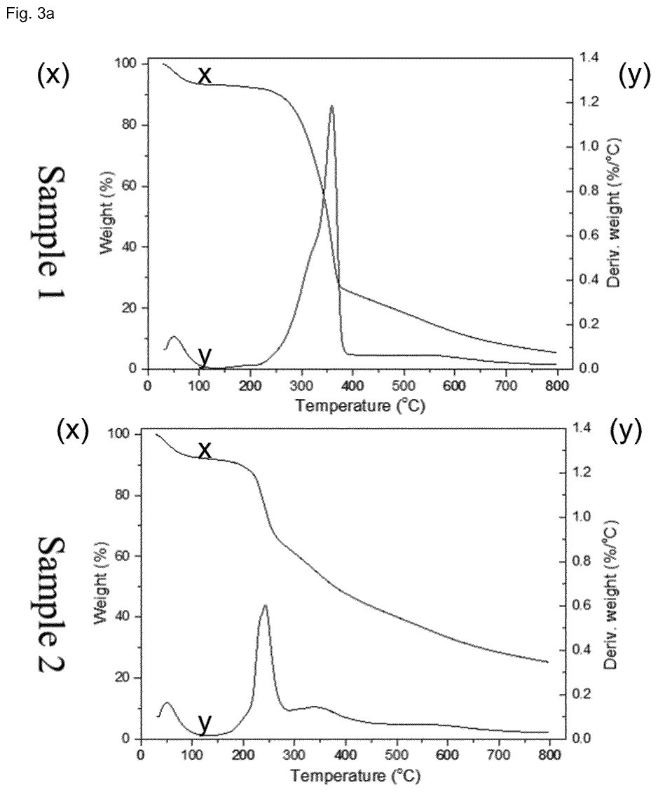

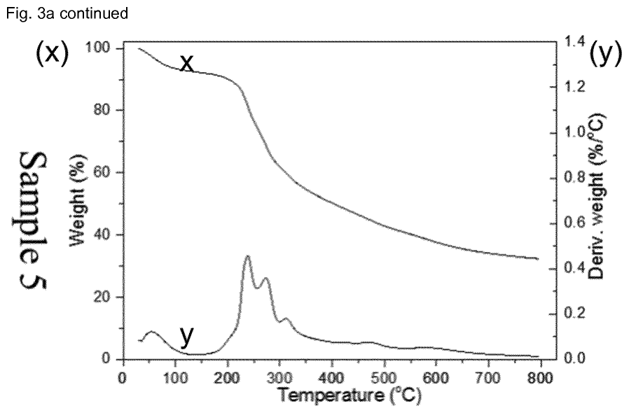

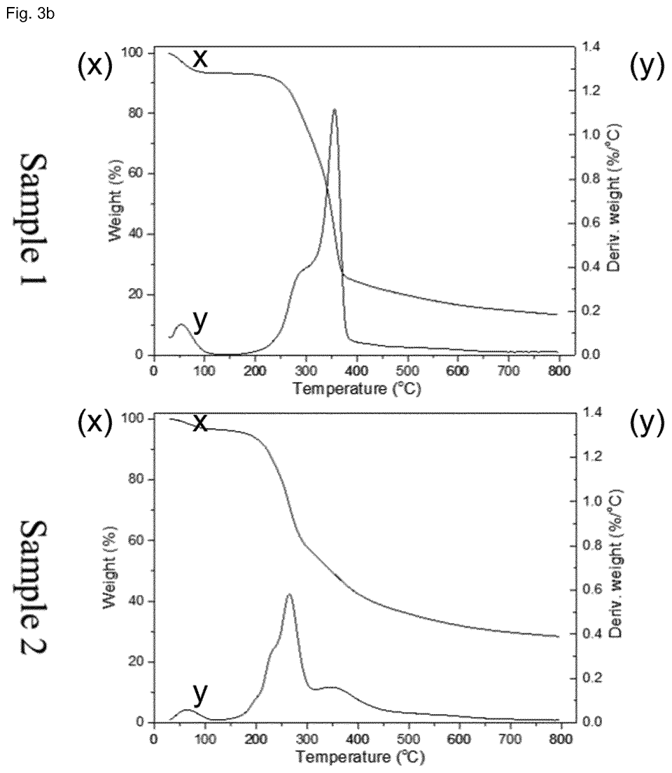

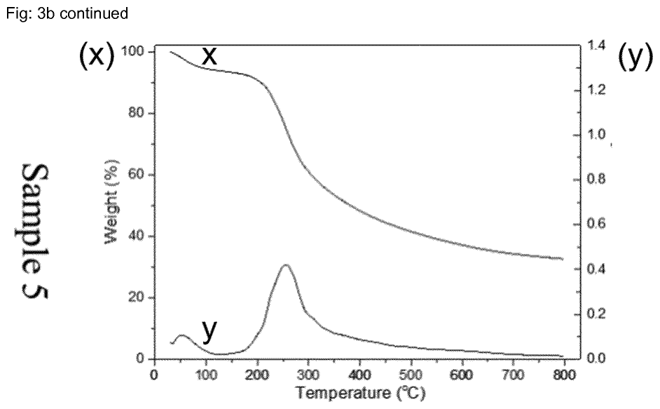

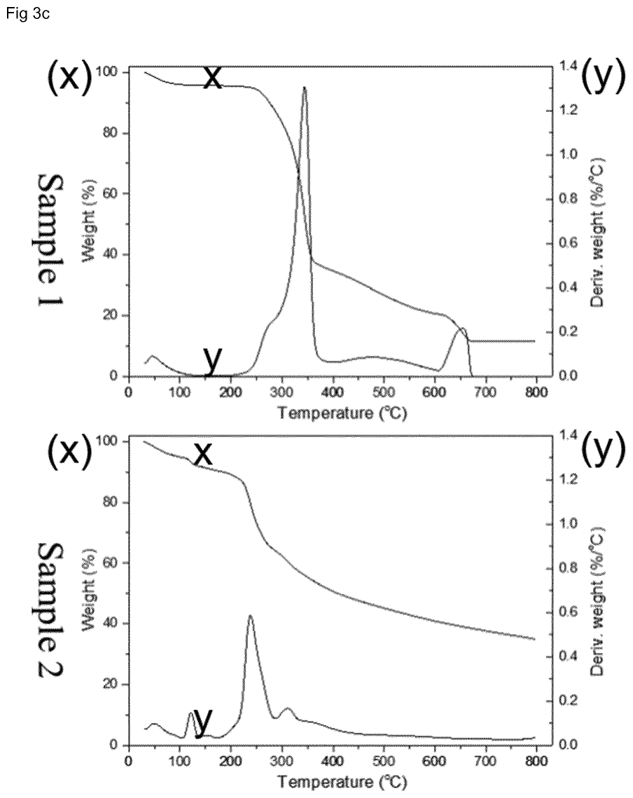

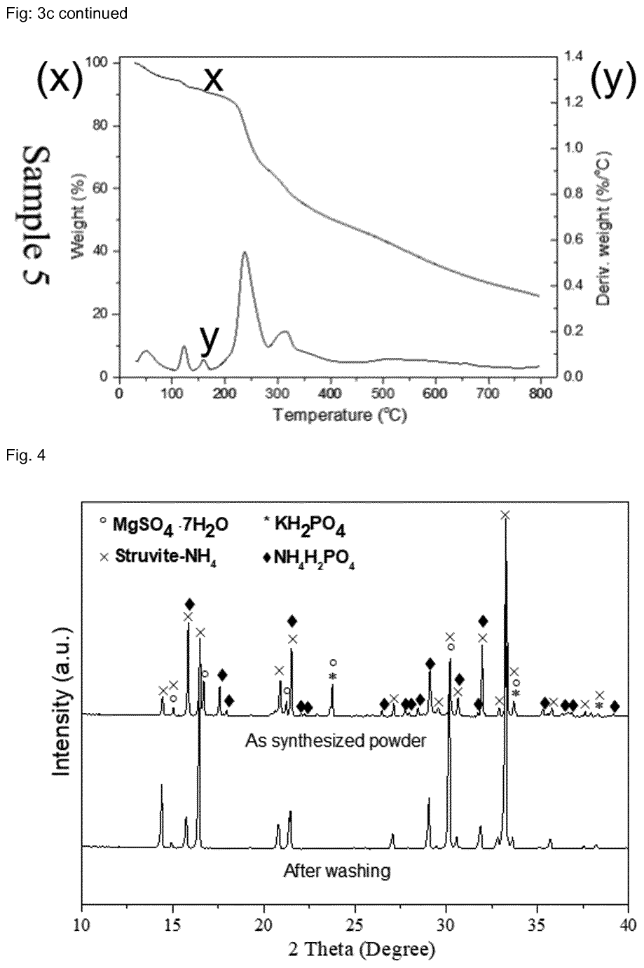

The thermal degradation behavior of spruce veneers, beech veneers and paper sheets was studied by TG (FIG. 3). It is important that the minerals decompose prior to the wood materials. Firstly, the decomposition of the minerals absorbs heat; secondly, the out gases from the mineral decomposition can dilute the flammable gas released by wood; thirdly, the resulted Al₂O₃ coating on the surface of wood cell walls, which obstruct the direct contact between oxygen and wood. As can be seen in FIG. 3, the unmodified samples have a sharp weight loss between 250 to 400° C., owing to the decomposition of hemicellulose with a peak at around 300° C., and the decomposition of cellulose with a peak at around 350° C. The DTG curves of the samples with a small amount of minerals embedded (Sample 2 as mentioned in Table 3 to 5) display a main decomposition peak at around 250° C. due to the decomposition of Aluminum hydroxide hydrate. As a result, a very slow decomposition of wood veneers or paper sheets was observed, with a weight loss lower than 0.2%/° C. in the temperature range above 300° C. The decomposition temperatures range of the minerals in wood could be extended higher than 300° C., which partly overlap with the decomposition temperature of wood, when the amount of minerals in wood increased (Sample 5, FIG. 3). It results in an even lower wood and paper decomposition rate.

### Example 2: Insertion of Struvite

Struvite with a chemical formula of Magnesium Ammonium Phosphate Hexahydrate [MgNH₄PO₄.6H₂O] is one of the phosphate containing biominerals with common occurrence in a wide variety. Once the NH⁴⁺ cations in Struvite are replaced by the K⁺ cations, it forms Struvite-K a well-defined potassium analogue of Struvite. It was identified as a mineral at two different locations: 1) at the famous sulphosalt locality of Lengenbach in Binntal, Switzerland, in a dolomitic rock of Triassic age; 2) at Rossblei, Austria, in an abandoned galena mine. Struvite-K was approved as a new inorganic phosphate mineral by the Commission on New Minerals and Mineral Names, International Mineralogical Association (CNMMN-IMA) in the year 2003. The motivation to form Struvite/Struvite-K in wood for fire retardancy includes the following three points: firstly, it is an eco- and health friendly biomineral that is ubiquitous in nature; secondly, Struvite decomposes in the temperature ranging from 100° C. to 200° C., which is lower than that of wood; thirdly, the phosphate compound may cross link the cellulose or hemicellulose at high temperature.

In this work, the aqueous solution of magnesium sulfate and potassium dihydrogen phosphate was impregnated into wood. The mineralization was induced by changing the pH value of the solution inside wood by ammonium hydroxide fumigation. The generation of Struvite was verified by X-ray powder diffraction (XRD). FIG. 4, black line demonstrates that the as generated powder contained MgSO₄.7H₂O, Struvite, KH₂PO₄, and NH₄H₂PO₄. The powder could be purified by washing with water (FIG. 4, grey line).

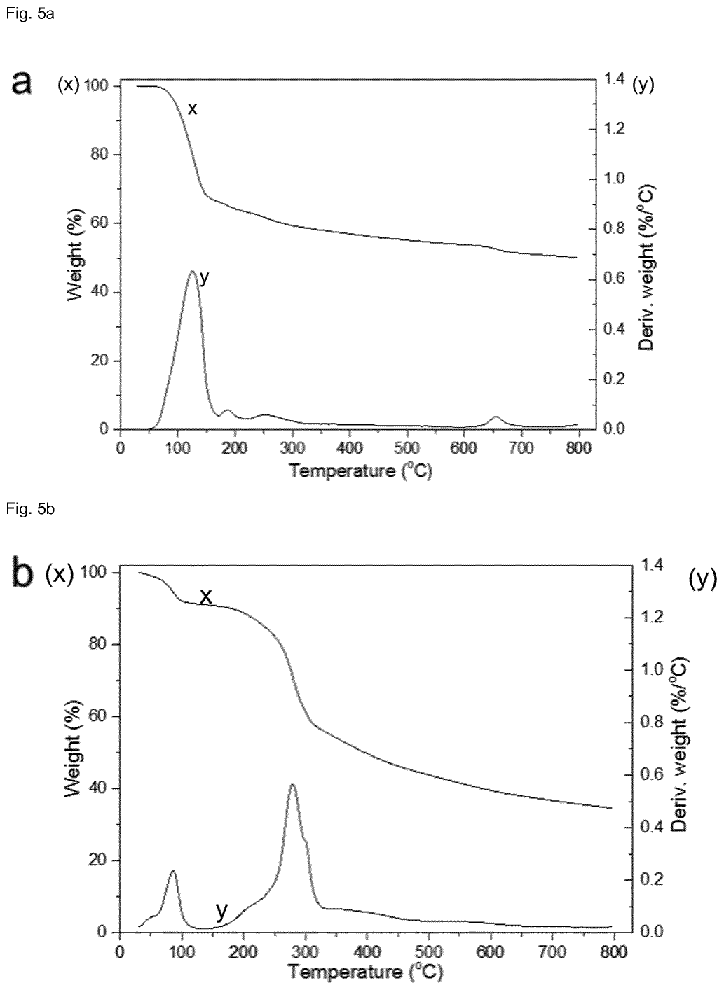

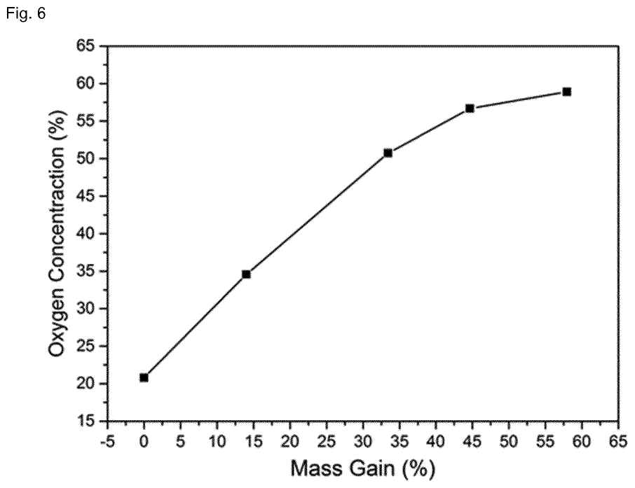

FIG. 5b displays the TG and DTG curves of the spruce wood with 31.3% (mass gain) of Struvite. The DTG curve shows a peak located before 100° C. attributed to the release of physical absorbed water. Another peak located at 280° C. relates to the decomposition of Struvite (release of crystallization water). The higher temperature compared to the free standing Struvite powder (FIG. 5a) is because a mineral and carbon composite layer forms on the surface of the samples, which obstructs the heat penetration. Therefore, a high ambient temperature is required for the decomposition of the internal mineral. At the temperature range higher than 320° C., the tardy decomposition of wood is observed (FIG. 5b). The residue is 34.3%, in which 20% is from the minerals while the other 14.3% is from wood.

The direct fire retardant performance was assessed by LOI measurement. The results demonstrate that the formation of Struvite in wood veneers increases their flame retardancy. The modified spruce veneer has a LOI value of 44.77 with a 31.3% mass gain (Table 6).

TABLE 6
The mass gain and LOI index of spruce
veneer impregnated with Struvite.

| | | | | | Mass Gain | |
|---|---|---|---|---|---|---|
| | KH₂PO₄ | | MgSO₄ | | of spruce | |
| Sample Number | Concentration | | Concentration | | veneer | LOI |
| 1 | 0 | g/mL | 0 | g/mL | 0% | 20.8 |
| 2 | 85 | mg/mL | 75 | mg/mL | 31.30% | 44.77 |

### Example 3

Wood veneer with a thickness of 0.53 or 0.85 mm is cut into a dimension of 10 cm by 15 cm. The salt solution is prepared by dissolving 5 g of Aluminum sulfate octadecahydrate (CAS: 7784-31-8) in 50 mL water. Two pieces of the wood veneer are soaked in the salt solution overnight. The hydrolysis process is carried out by ammonium hydroxide fumigation. A vial with 20 mL of Ammonium hydroxide solution (CAS: 1336-21-6) is put in the center of a plastic box. The two pieces of wood veneer are removed from the salt solution into the plastic box which is then sealed by a lid. After 6 hours, the wood veneers are transferred from the plastic box into the 65° C. oven for drying.

### Example 4

Wood fiberboard with a dimension of 3 cm×10 cm×30 cm is made of wood fibers by hot pressing. The salt solution is prepared by dissolving 5 g of Aluminum sulfate octadecahydrate (CAS: 7784-31-8) in 50 mL water. The salt solution is then sprayed onto the fiberboard in three times. Thirty minutes after the spraying, the fiberboard is transferred into a plastic box with a glass vial which contains 20 ml of Ammonium hydroxide solution.

### Example 5

A spruce panel with a dimension of 100 mm×100 mm×10 mm in longitudinal×radial×tangential direction was put into a plastic box. The plastic box was loaded into a vacuum chamber. The vacuum chamber was then pumped down to about 15 mbar. Aluminum sulfate octadecahydrate solution with a concentration of 50 mg/mL was injected into the plastic box already in the vacuum chamber until the wood panels were covered by the solution completely. The chamber was kept under vacuum for another half hour before the vacuum was released. The sample was kept in the solution for an additional hour. After that, the samples were taken from the solution and put into a dry plastic box together with a bottle of ammonium hydroxide solution. The plastic box was closed by a lip. The ammonium hydroxide fumigation was carried out at room temperature for 6 h. Finally, the wood veneers were transferred from the plastic box into the 65° C. heated oven for drying. The concentration of Aluminum sulfate octadecahydrate solution can be changed from 0 mg/mL to saturated solution.

### Example 6

For the growth of Struvite in wood, the mixed solution of magnesium sulfate heptahydrate (MgSO₄.7H2O, CAS: 10034-99-8) and potassium dihydrogen phosphate (KH₂PO₄, CAS: 7778-77-0) was impregnated into wood. The aqueous solution of potassium dihydrogen phosphate (85 mg/mL) and magnesium sulfate heptahydrate (75 mg/mL) was filled into the plastic box with wood veneers, which was already in the vacuum chamber. The chamber was kept under vacuum for another half hour before the vacuum was released. The sample was kept in the solution for an additional hour. After that, the samples were taken from the solution and put into a dry plastic box together with a bottle of ammonium hydroxide solution. The plastic box was closed by a lip. The ammonium hydroxide fumigation was carried out at room temperature for 6 h. The wood veneers were transferred from the plastic box into the 65° C. heated oven for drying.

### Example 7

Zinc potassium phosphate hexahydrate (ZnKPO₄.6H₂O) was grown inside wood by reacting Potassium dihydrogen phosphate with Zinc Sulphate (ZnSO₄.7H2O, CAS: 7446-20-0) inside wood at room temperature without any additional reactant or initiator. A solution of potassium dihydrogen phosphate with a concentration of 85 mg/mL was vacuum impregnated into spruce wood veneers. Then, the wood veneers were soaked in the aqueous solution of zinc sulfate heptahydrate (179 mg/mL) for 2 hours. The wood samples were removed from the solution, and stored under ambient conditions. The ZnKPO₄.6H₂O crystals grow inside wood as the water slowly evaporated. After 12 hours, the wood samples were removed and stored in an oven for drying at 65° C.

1. A method for the treatment of cellulosic material comprising the steps
a. impregnation of the cellulosic material with
a metal ion M and at least one ion precursor Z, wherein Z provides an anion A or an anion A and a cation Y, comprised within at least one metal salt solution I,
or with comprising a metal ion M, comprised within a metal salt solution II, yielding an impregnated cellulosic material,
b. treatment of the impregnated cellulosic material by a fumigation step or an evaporation step yielding a cellulosic composite material comprising a compound M(NH₄)A, MYA or M(OH)ₓ, wherein M is a metal cation, Y is a cation, A is an anion and x equals the oxidation number of M.

2. The method according to claim 1, wherein the impregnated cellulosic material is fumigated with NH₃.

3. The method according to claim 1, wherein at least one ion precursor Z of said metal salt solution I provides an anion A in the impregnation step and NH₃ is used in the fumigation step.

4. The method according to claim 1, wherein said metal salt solution II is used in the impregnation step and NH₃ is used in the fumigation step.

5. The method according to claim 1, wherein the at least one ion precursor Z provides an anion A and a cation Y or at least two ion precursors Z provide an anion A and a cation Y, wherein one ion precursor Z provides an anion A and the other ion precursor Z provides a cation Y, in the impregnation step followed by an evaporation step.

6. The method according to claim 1, wherein the evaporation occurs with the proviso that a base additive is not added.

7. The method according to claim 1, wherein
M is selected
in the case of metal salt solution I, from Mg²⁺, Ca²⁺, Sr²⁺, Ba²⁺ and Zn²⁺, Fe²⁺ in particular Mg²⁺, Ca²⁺, Ba²⁺ and Zn²⁺, more particularly Mg²⁺ and Zn²⁺, and/or
in the case of metal salt solution II, from Al³⁺, Mg²⁺, Zn²⁺, Ni²⁺, In³⁺, Fe²⁺ and Fe³⁺, in particular Al³⁺ and Mg²⁺, more particularly Al³⁺.

8. The method according to claim 1, wherein Y is selected from an alkali metal ion and NH₄⁺, in particular NH₄⁺, Li⁺, Na⁺ and K⁺, more particularly NH₄⁺ and K⁺ if the evaporation step is applied in step b.

9. The method according to claim 1, wherein A is phosphate.

10. The method according to claim 1, wherein
in the case of metal salt solution I, a protic solvent, in particular alcohol or water, more particularly water is used for the impregnation step, or
in the case of metal salt solution II, a solvent with a water content of at least 10%, in particular a protic solvent, more particularly alcohol or water, more particularly water is used for the impregnation step.

11. The method according to claim 1, wherein during the impregnation and/or treatment with an alkaline solution
a negative pressure, in particular 1 mbar to 800 mbar, more particularly 5 mbar to 50 mbar, is applied, and/or
a positive pressure, in particular 3 bar to 25 bar, more particularly 6 bar to 9 bar is applied.

12. A cellulosic composite material obtainable by a method according to claim 1, wherein the composite material has:
a LOI of 30 to 60, in particular 35 to 55, most particular 40 to 50; and/or
a weight percentage of the compound M(NH₄)A, MYA or M(OH)ₓ of 5 wt % to 60 wt %, in particular 30 wt % to 55 wt %, most particular 40 wt % to 55 wt %.

13. A cellulosic composite material comprising a compound M(NH₄)A, MYA or M(OH)ₓ, wherein said compound is present on the surface of the cell wall, in particular on the lumen surface of the cell wall, M is a metal cation, Y is a cation, A is an anion and x equals the oxidation number of M, with the proviso that said compound is not MgNH₄PO₄.

14. The cellulosic composite material according to claim 1, wherein the compound MYA decomposes at a temperature below 200° C., in particular below 150° C. and the compound M(OH)ₓ decomposes at a temperature below 350° C., in particular below 300° C., more particularly below 280° C.

15. The cellulosic composite material according to claim 1, wherein M is selected
in the case of M(NH₄)A, from Mg²⁺, Ca²⁺, Sr²⁺, Ba²⁺ and Zn²⁺, in particular Mg²⁺, Ca²⁺, Ba²⁺ and Zn²⁺, more particularly Mg²⁺ and Zn²⁺,
in the case of MYA, from Mg²⁺, Ca²⁺, Sr²⁺, Ba²⁺ and Zn²⁺, in particular Mg²⁺, Ca²⁺, Ba²⁺ and Zn²⁺, more particularly Mg²⁺ and Zn²⁺, or
in the case of M(OH)ₓ, from Al³⁺, Mg²⁺, Zn²⁺, Ni²⁺ and In³⁺, in particular Al³⁺ and Mg²⁺, more particularly Al³⁺.
